(19) United States
(12) Patent Application Publication
(10) Pub. No.: US 2008/0135537 A1
(43) Pub. Date: Jun. 12, 2008

(54) Apparatus and method for cordless electric curling iron with adjustable diameter barrel

(76) Inventors: Edward H. Suber, Akron, OH (US); Carey Layton, Akron, OH (US)

Correspondence Address: PATENT, COPYRIGHT & TRADEMARK LAW GROUP, PO BOX 506, RICHFIELD, OH, 44286, US

(21) Appl. No.: 12/001,271

(22) Filed: Dec. 11, 2007

Related U.S. Application Data
(60) Provisional application No. 60/874,013, filed on Dec. 11, 2006.

(51) Int. Cl. A45D 1/04; H05B 1/00; H05B 3/00

(52) U.S. Cl. 219/225; 132/232; 219/240

(57) ABSTRACT

A cordless electric curling iron having a barrel that adjusts in diameter to achieve curls of varied tightness and bounce. The barrel adjusts by means of a dial proximate to a handle. A flexible, resilient grasping arm conforms to the curvature of the barrel so that it maintains an adjacent position hugging the barrel at all times. The present curling iron further comprises an internal ratchet mechanism that provides a means to eliminate a winding of the handle round to wrap hair around the barrel; rather, the ratcheting mechanism only requires the handle be swung in a back-and-forth motion to perform partial rotations of the barrel that combine to full rotations.

### RELATED APPLICATIONS

The present invention claims a benefit to U.S. Provisional Patent Application Ser. No. 60/874,013, filed Dec. 11, 2006. The subject matter of the '013 Provisional Patent Application is incorporated by reference herein as if it is rewritten in its entirety.

### BACKGROUND OF THE INVENTION

1. Field of the Invention

The present invention relates generally to a curling iron and, more specifically, to a cordless electric curling iron having a barrel that adjusts in diameter to change a tightness or a bounce of curls. The curling iron further comprises a novel, ratchet style handle that provides a means to achieve a constant grip on the handle of the curling iron.

2. Description of the Related Art

Conventional curling irons are used by consumers and professional stylists to create curls in one's hair that typically does not occur naturally. Current curling irons are available in a number of barrel diameters to create different sized curls. When a stylist or individual desires to create a hair style that consists of curls of different sizes, additional curling irons must be purchased and used simultaneously. This creates the need for more storage space to be used and also creates a danger of multiple cords being tangled together. The need to use multiple curling irons at the same time also creates additional expenses for the user and the need for multiple power outlets. A battery-powered curling iron is disclosed in U.S. Pat. No. 4,857,702 to Cafaro. The curling iron handle comprises rechargeable batteries to supply the power to the heating element. The barrel of Cafaro's curling iron is not adjustable to allow for making hair curls of different diameter.

Friedman teaches a curling iron with an adjustable barrel in the U.S. Pat. 6,014,977. The barrel has two adjustable positions that are controlled by moving the clip assembly that is connected to the barrel. The hair curling iron disclosed by Friedman does not support cordless operation. Thus there is a need for a curling iron to include an adjustable barrel that increases or decreases in diameter to create curls of different sizes.

When curling the hair, the hair is placed between the clamp and barrel and then the user holds the tip of the curling iron with one hand and rotates the handle with the other hand. It is necessary for the user to continuously release the grip held on the handle and readjust to continue twisting the hair around the barrel until the desired piece of hair is wrapped. Using both hands at all times on the curling iron and the large circular motions of the wrist required to rotate the barrel create user fatigue. Thus there is a need for a curling iron to include a ratchet mechanism in the handle to allow the user to rotate the handle with smaller circular motions of the wrist and to allow the user to relieve the hand that was previously used to hold the opposite end of the curling iron for support.

### SUMMARY OF THE INVENTION

It is an object of the present invention to provide an apparatus and a method for a cordless electric curling iron with an adjustable diameter barrel and clip with a ratchet handle for easy curling.

It is a feature of the present invention to provide an improved curling iron that allows a user to change the effective diameter of the barrel in order to correspond to the desired size of the curl. The adjustable barrel is designed with a tight seal to prevent hair from catching on the adjustable barrel during use. An additional objective of the present invention is to provide a curling iron with an adjustable clip.

A further objective of the present invention is to provide a curling iron with a dial to set adjustment for the barrel and also for the clip that automatically adjusts with the diameter of the barrel.

Another feature of the present invention is a battery powered operation that allows the user to utilize the hair curling iron in locations that do not provide convenient access to power outlets.

A further feature of the present invention is a ratcheting mechanism that allows the user to roll a lock of hair without rotating the handle of the curling iron, but rather by means of a wrist-swinging motion backwards and forwards.

An additional objective of the present invention is to provide a curling iron with an adjustable clip and barrel wherein it may contain at least one heater element(s) is centrally disposed within the adjustable barrel such that the heat applied to the adjustable barrel is evenly distributed and set with temperature control.

A further feature of the present invention is at least one heater element for variable heating adjustment positions.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a side view of the apparatus for a cordless electric curling iron with an adjustable diameter barrel;

FIG. 2a is a front view of the adjustable barrel in its largest diameter setting;

FIG. 2b is a front view of the adjustable barrel in its smallest diameter setting;

FIG. 3 is a detailed view of an internal ratcheting mechanism; and,

FIG. 4 is a partial view of the curling iron of FIG. 1 removable charging on a docking station.

### DESCRIPTION OF THE PREFERRED EMBODIMENTS

The best mode for carrying out the invention is presented in terms of its preferred embodiment, herein described and depicted within the Figures.

### 1. Detailed Description of the Figures

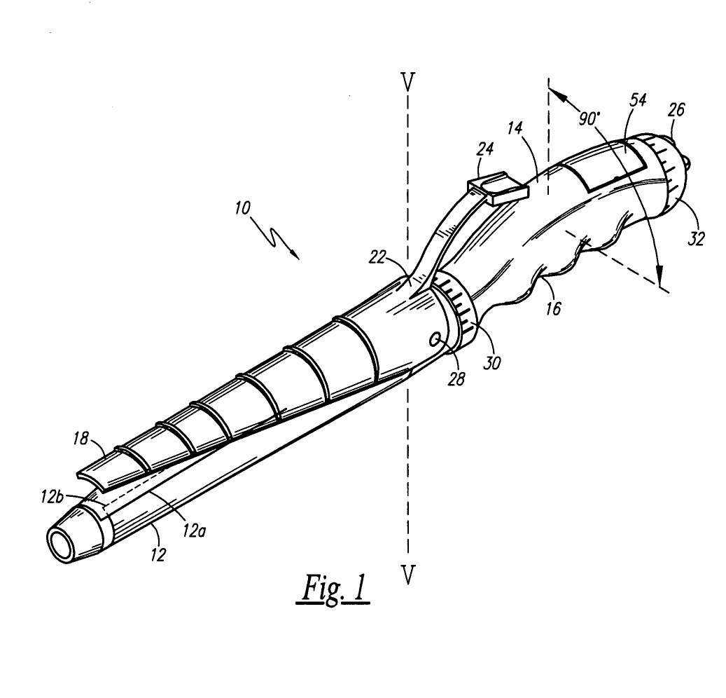

Referring to FIG. 1, an apparatus for curling hair with an adjustable barrel diameter is shown 10 in accordance with a preferred embodiment of the present invention. A barrel 12 is connected to a handle 14. The handle may be ouffitted with a comfort grip 16. The comfort grip 16 is ergonomically shaped to adjust to the contours of the user's hand to provide greater ease of operation. The handle 14 further features a diameter adjustment dial 30 disposed between the handle 14 and the barrel 12 of the apparatus 10. Additionally, the handle 14 also features a temperature control dial 32 located on its opposite end in relation to the diameter adjustment dial 30. It should be noted that a location of the dials 30 and 32 is not limited to the locations shown in FIG. 1, but it may be comprised anywhere on the curling iron where it is easy to access but not easy to obstruct. The temperature control dial 32 allows the user to activate the apparatus, to preselect a desired temperature setting as well as to turn off the apparatus 10.

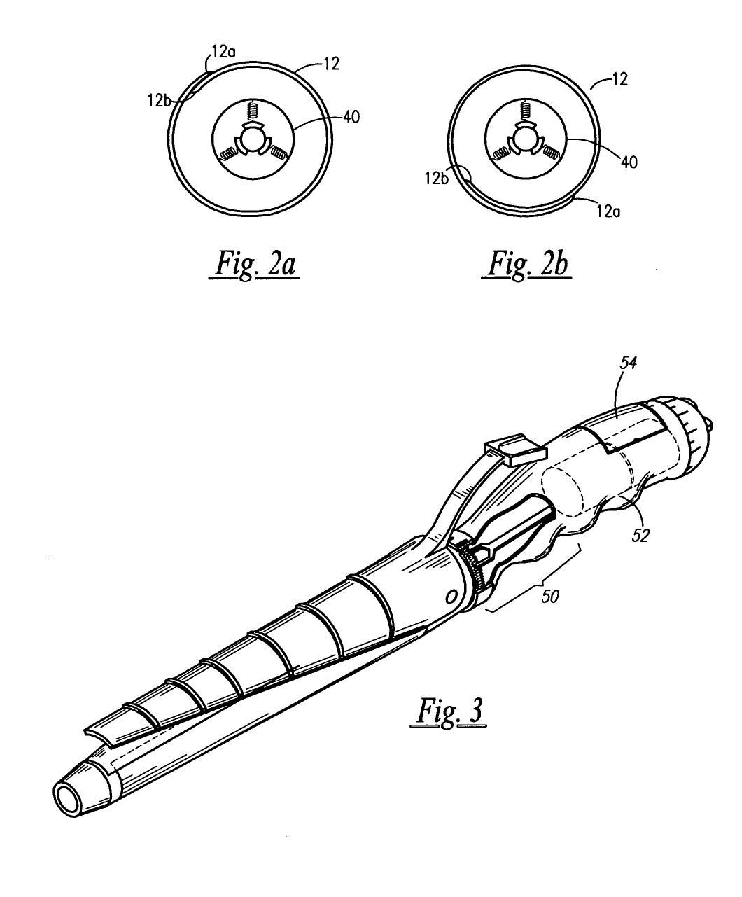

As shown in FIGS. 2a and 2b, the barrel 12 is a rectangular sheet of metal that is wrapped into a cylinder. The two ends 12a and 12b of the barrel 12, respectively, overlap to form a generally cylindrical shape. The sheet is not limited to the metal; it may comprise any material that conducts heat. A sleeve may be inserted over the barrel 12 to prevent hair from catching between the exposed end 12a and the sheet. The sleeve is fabricated of any resilient material that is capable of expanding with the barrel. The sleeve must be heat conductive, but it cannot be fabricated from a material that possesses a risk of catching fire.

The diameter of the barrel 12 is regulated by adjusting the position of ends 12a and 12b with respect to each other. The diameter adjustment dial 30 regulates the effective diameter of the barrel 12. The user can preselect the diameter of the barrel 12 by rotating the dial 30 to the desired setting. It is envisioned that the diameter of the barrel may be changed from 1 to 3 inches; however, other diameters are not precluded. FIG. 2a shows the barrel 12 in its largest diameter setting, while FIG. 2b shows the barrel 12 in its smallest diameter setting. Further illustrated in FIGS. 2a and 2b is at least one heat coil 40 that travels along a length of the cylindrical barrel at its center. Electric circuitry (not shown) connects the heat coil to an in internal battery (not shown) and the temperature control dial 32.

Attached to the barrel 12 is a means for grasping hair, shown here as a grasping arm 18 or clip. The grasping arm 18 is preferably placed on top of the barrel 12 or substantially near the top of the barrel 12. Preferably, the grasping arm 18 is coupled to a support arm 22, which is pivoted off of a pin 28. The end of the support arm 22 that is proximate to the handle 14 may have a pad 24 to enhance the ergonomic comfort. The grasping arm 18 is configured such that when the user places pressure on the pad 24, the grasping arm 18 pivots and the distance between the barrel 12 and the grasping arm 18 is increased. This allows the user to place a lock of hair in the void between the barrel 12 and the grasping arm 18. After the pressure on the pad 24 is released, the grasping arm is urged into its previous position by a spring mechanism (not shown). This allows the user to securely grasp a lock of hair and curl it around the barrel.

The grasping arm 18 is manufactured from a resilient, flexible material that is still rigid enough such that it adopts a curvature of the barrel 12. The material must be capable of transferring heat from the barrel 12 to an exterior of the grasping arm 18 such that the hair in contact with the arm achieves the curl. It is anticipated that as the barrel 12 is adjusted, the angle of curvature of the grasping arm 18 expands or contracts to continually maintain an adjacent relationship with the barrel at all points.

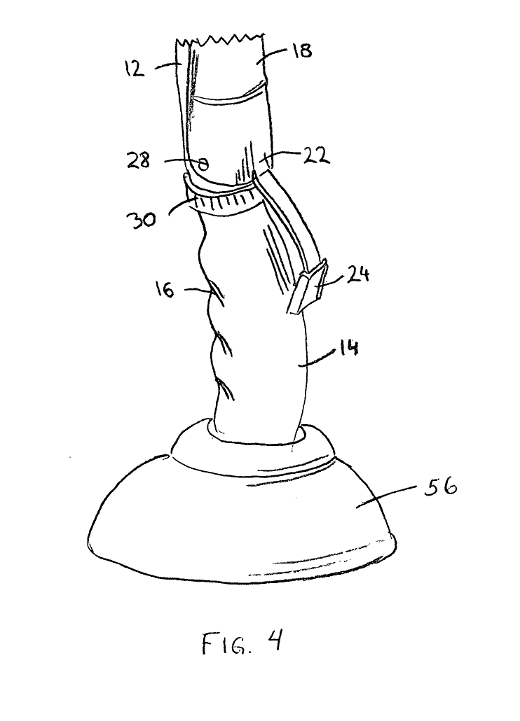

The handle 14 may be configured with a charger receiver 26. The handle 14 preferably comprises a battery removably contained within an interior portion 52 (shown in FIG. 3) of said handle. The battery may be a replaceable battery accessed by means of a door 54 or it may be a similar power device to allow for cordless operation. It is preferred that the battery is a rechargeable battery that receives power by means a docking station 56 shown in FIG. 4, which is capable of plugging into a power outlet to receive power.

The curling iron 10 further contains an internal ratcheting mechanism 50 that allows the user to keep a constant grip on the handle without having to reposition their hand on it because it no longer requires a full winding around a lock of hair. FIG. 3 illustrates the ratcheting mechanism 50 housed inside the handle 12. The ratcheting mechanism allows the barrel 12 to partially rotate independently of the handle 14. More specifically, the paw of the ratchet sits on a gear such that the user can rotate their wrist in a swinging back-and-forth motion to crank the gear. Each crank tightens the paw and locks it in place such that a full rotation of the curling iron 10 is not necessary. The ratcheting mechanism comprises a gearset which rotates the barrel 12 with respect to the handle 14. A ratcheting lever only permits the barrel to rotate in one direction so that the barrel completes full rotations by means of a plurality of partial rotations, each accomplished by the wrist's back-and-forward motion.,

### 2. Operation of the Preferred Embodiment

To use the present invention, the user first activates the apparatus 10 and sets the desired temperature using the temperature control dial 32. Following this, the user then adjusts the barrel 12 to the desired diameter by using the dial 30. The user then opens the distance between the barrel 12 and the grasping arm 18 by pressing down on the pad 24. The user can then place the hair in the space between the barrel 12 and the grasping arm 18 and then release the pad 24, thus decreasing the distance and securing the lock of hair between the barrel 12 and the grasping arm 18. The ratcheting mechanism 50 allows the user to roll the hair curling iron 10 around a lock of hair without repositioning their grip on the handle 14. The user then simply maneuvers the curling iron 10 in a manner that will create the desired curl.

The foregoing descriptions of specific embodiments of the present invention are presented for purposes of illustration and description. They are not intended to be exhaustive nor to limit the invention to the precise forms disclosed and, obviously, many modifications and variations are possible in light of the above teaching. The embodiments are chosen and described in order to best explain the principles of the invention and its practical application, to thereby enable others skilled in the art to best utilize the invention and its various embodiments with various modifications as are suited to the particular use contemplated. It is intended that the scope of the invention be defined by the Claims appended hereto and to their equivalents. Therefore, the scope of the invention is to be limited only by the following claims.

Having thus described the invention what is claimed as new and desired to be secured by Letters Patent is as follows:

1. A curling iron, said curling iron comprises:
a cylindrical shaped barrel having an adjustable cross-section;
a grasping arm, said grasping arm is a resilient and a flexible clip material that conforms to a curvature of said barrel, said clip material is capable of transferring heat from said barrel; and,
a ratchet handle;
wherein said diameter of said barrel adjusts such that a tighter or a bouncier curl is achieved.

2. The curling iron of claim 1, wherein said handle is outfitted with a comfort grip that is ergonomically shaped to adjust to a contour of a hand.

3. The curling iron of claim 1, further comprising a temperature control dial provided as a means to adjust a temperature of said barrel.

4. The curling iron of claim 3, further comprising at least one heater element centrally disposed within said adjustable barrel such that heat applied to said adjustable barrel and said clip is evenly distributed, said heat is set with temperature control.

5. The curling iron of claim 4, further comprising a barrel and clip adjustment dial provided as a means to adjust a diameter of said barrel.

6. The curling iron of claim 5, wherein said temperature control dial and said barrel and clip adjustment dial are both proximate to or positioned on said handle.

7. The curling iron of claim 1, wherein said barrel is formed of a rectangular sheet that is wrapped such that two ends of said sheet respectively overlap to form a generally cylindrical shape, said diameter of said barrel is regulated by an adjustment of a position of said two ends with respect to one another.

8. The curling iron of claim 7, further comprising a sleeve inserted over said barrel to prevent hair from catching between an exposed end of said sheet.

9. The curling iron of claim 1, further comprising at least one heat coil that travels along a length of said cylindrical shaped barrel at its center.

10. The curling iron of claim 1, wherein said grasping arm is coupled to a support arm proximate to said handle, said support arm comprises a pad and is pressed by a user to open a distance between said grasping arm and said barrel.

11. The curling iron of claim 1, further comprising an internal ratcheting mechanism provided as a means to allow a user to maintain a constant grip on said handle without having to reposition their hand on it because said ratcheting mechanism no longer requires a full winding of said handle, said ratcheting mechanism allows said barrel to partially rotate by means of a paw that sits on a gear, the user rotates a wrist in a swinging back-and-forth motion to crank said gear, wherein each crank tightens said paw and locks it in place.

12. The curling iron of claim 1, further comprising a charger receiver, said charger receiver is capable of connecting to a docking station.

13. The curling iron of claim 1, wherein said curling iron is a cordless device, said curling iron receives power by means of a battery removably contained within an interior portion of said handle.

14. The curling iron of claim 12, wherein said curling iron is a cordless device, said curling iron receives power by means of a rechargeable battery contained in an interior portion of said handle, said rechargeable battery is charged by means of said docking station.

15. A method of using a curling iron having an adjustable diameter barrel, said method comprises the steps:
charging a rechargeable battery contained in an interior portion of a handle of said curling iron by means of a charger receiver comprised on said handle;
activating said curling iron by means of a temperature adjustment dial;
setting a temperature of a cylindrical barrel of said curling iron by means of said temperature adjustment dial;
adjusting a cross section of said cylindrical barrel by means of a barrel adjustment dial, a diameter of said barrel increases for a bouncier curl and a diameter of said barrel decreases for a tighter curl;
placing pressure on a support arm to open a distance between a grasping clip and said barrel;
placing a tip of hair between said grasping clip and said barrel;
releasing said pressure on said support arm such that said grasping clip closes over to hug said barrel such that the hair is pressed against said barrel; and,
swinging said handle in a back-and-forth manner such that an internal ratcheting mechanism partially rotates said barrel at each swing to crank a gear and tighten a paw in place.

16. A curling iron, said curling iron comprises:
a cylindrical shaped barrel;
a grasping arm, said grasping arm conforms to a curvature of said barrel, said clip material is capable of transferring heat from said barrel; and,
a handle comprising an internal ratcheting mechanism provided as a means to allow a user to maintain a constant grip on said handle without having to reposition their hand on it because said ratcheting mechanism no longer requires a full winding of said handle, said ratcheting mechanism allows said barrel to partially rotate by means of a paw that sits on a gear, the user rotates a wrist in a swinging back-and-forth motion to crank said gear, wherein each crank tightens said paw and locks it in place.

17. The curling iron of claim 16, wherein said cylindrical shaped comprises a constant length and an adjustable cross-section, said barrel is formed of a rectangular sheet that is wrapped such that two ends of said sheet respectively overlap to form a generally cylindrical shape, said diameter of said barrel is regulated by an adjustment of a position of said two ends with respect to one another, said curling iron further comprises a barrel adjustment dial provided as a means to adjust a diameter of said barrel.

18. The curling iron of claim 16, further comprising a sleeve inserted over said barrel to prevent hair from catching between an exposed end of said sheet.

19. The curling iron of claim 17, wherein said handle is outfitted with a comfort grip that is ergonomically shaped to adjust to a contour of a hand.

20. The curling iron of claim 18, further comprising a temperature control dial provided as a means to adjust a temperature of said barrel, said temperature control dial and said barrel adjustment dial are both proximate to or positioned on said handle.
